(19) United States
(12) Patent Application Publication
(10) Pub. No.: US 2025/0078471 A1
(43) Pub. Date: Mar. 6, 2025

(54) GENERATING LABELLED TRAINING DATA FOR CREATING HIGH-PERFORMING AI SYSTEMS USING LARGE LANGUAGE MODELS

(71) Applicant: Siemens Healthineers AG, Forchheim (DE)

(72) Inventors: Sasa Grbic, Plainsboro, NJ (US); Dorin Comaniciu, Princeton, NJ (US)

(21) Appl. No.: 18/456,888

(22) Filed: Aug. 28, 2023

(51) Int. Cl. G06V 10/774; G06V 10/776; G06V 10/96; G06V 20/70

(52) U.S. Cl. CPC G06V 10/774; G06V 10/776; G06V 10/96; G06V 20/70; G06F 40/40

(57) ABSTRACT

Systems and methods for assigning labels to medical images are provided. One or more prompts comprising instructions for assigning labels to medical images are received. The labels are assigned to the medical images using a large language model based on 1) the instructions and 2) patient data stored in a plurality of patient databases. The assignment of the labels to the medical images is output.

### TECHNICAL FIELD

The present invention relates generally to large language models, and in particular to generating labelled training data for creating high-performing AI (artificial intelligence) systems using large language models.

### BACKGROUND

Recently, AI systems have been proposed to assist in clinical workflows to improve efficiency and patient care. AI systems are typically trained using supervised learning, which requires labelled training data, such as, e.g., a medical image that is positive for lung cancer or a pathology slide that is positive for adenocarcinoma. The quality and quantity of labelled training data dictates the achievable performance of the AI systems. Currently, most AI systems are trained using labels derived from human annotators, which are of medium quality, or labels automatically derived from natural language processing, which are of low quality, resulting in AI systems that do not perform as well as AI systems trained using higher quality labels. However, there is currently no known techniques for generating high quality labelled training data on a large scale.

### BRIEF SUMMARY OF THE INVENTION

In accordance with one or more embodiments, systems and methods for assigning labels to medical images are provided. One or more prompts comprising instructions for assigning labels to medical images are received. The labels are assigned to the medical images using a large language model based on 1) the instructions and 2) patient data stored in a plurality of patient databases. The assignment of the labels to the medical images is output.

In one embodiment, the assignment of the labels to the medical images is output by storing, by the large language model, the medical images according to a file structure defined based on the assigned labels. The medical images are stored by the large language model in a computer folder defined for their assigned labels.

In one embodiment, the one or more prompts further comprise additional instructions for assigning a level of confidence to each of the assigned labels. The level of confidence is assigned to each of the assigned labels using the large language model based on the additional instructions. In one embodiment, the level of confidence is assigned to each of the assigned labels based on the patient data used to assign the labels to the medical images.

In one embodiment, an artificial intelligence system is trained for performing a medical imaging analysis task based on the medical images and the assigned labels.

In one embodiment, the plurality of patient databases comprises at least one of EHR (electronic health record), EMR (electronic medical record), PHR (personal health record), HIS (health information system), RIS (radiology information system), PACS (picture archiving and communication system), and LIMS (laboratory information management system).

These and other advantages of the invention will be apparent to those of ordinary skill in the art by reference to the following detailed description and the accompanying drawings.

### BRIEF DESCRIPTION OF THE DRAWINGS

FIG. 1 shows a method for generating labelled training data, in accordance with one or more embodiments;

FIG. 2 shows a workflow for generating labelled training data, in accordance with one or more embodiments;

FIG. 3 shows an exemplary artificial neural network that may be used to implement one or more embodiments;

FIG. 4 shows a convolutional neural network that may be used to implement one or more embodiments; and

FIG. 5 shows a high-level block diagram of a computer that may be used to implement one or more embodiments.

### DETAILED DESCRIPTION

The present invention generally relates to methods and systems for generating labelled training data for creating high-performing AI systems using LLMs (large language models). Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

The scalable creation of high-quality labelled training data across multiple clinical institutions and countries is an important step in the training of high-performing AI systems for performing medical imaging tasks. Embodiments described herein provide for the automatic generation of labelled training data in a scalable manner using a large language model based on patient data stored in a plurality of patient databases. Advantageously, the generation of labelled training data in accordance with embodiments described herein is performed in a cost-efficient manner without requiring manual data curation.

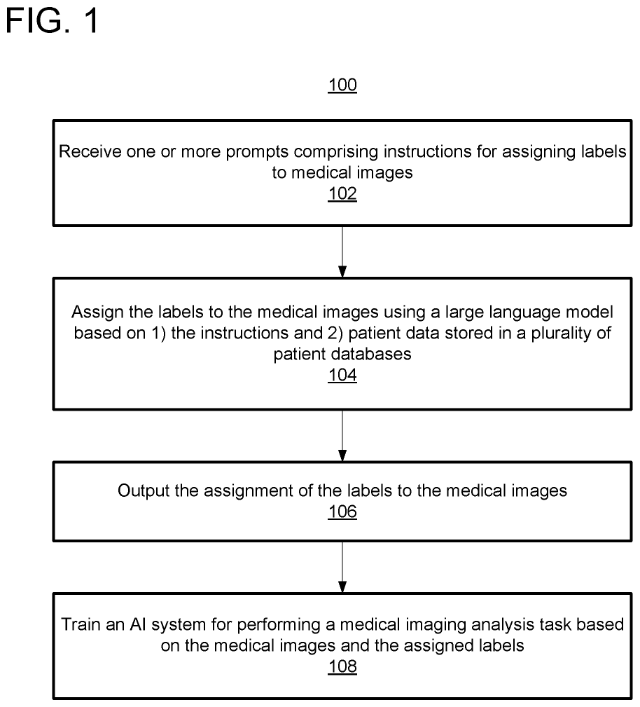

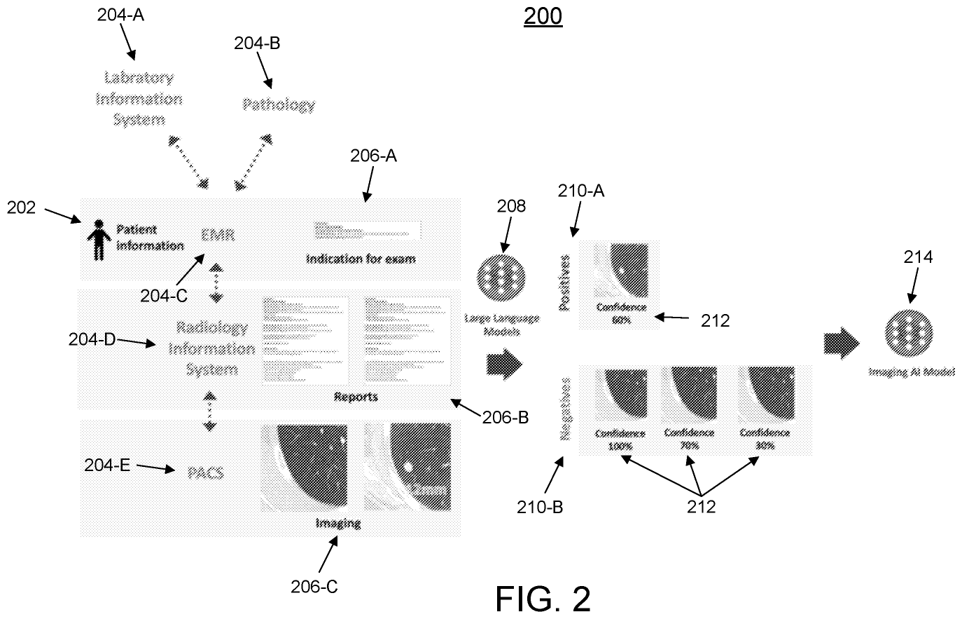

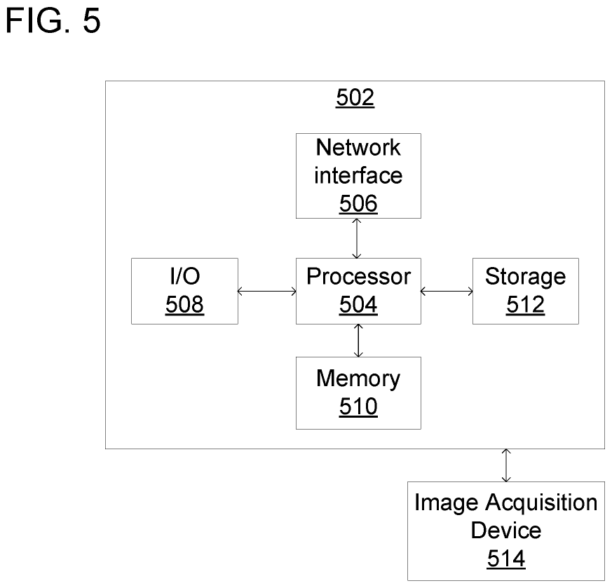

FIG. 1 shows a method 100 for generating labelled training data, in accordance with one or more embodiments. The steps of method 100 may be performed by one or more suitable computing devices, such as, e.g., computer 502 of FIG. 5. FIG. 2 shows a workflow 200 for generating labelled training data, in accordance with one or more embodiments. FIG. 1 and FIG. 2 will be described together.

At step 102 of FIG. 1, one or more prompts comprising instructions for assigning labels to medical images are received. A prompt refers to input text to an LLM for generating a response. A prompt is typically provided by a user to enable the user to interact with the LLM. The one or more prompts may be received from a computing device (e.g., computer 502 of FIG. 5) with which a user is interacting.

An instruction refers to guidelines or directions provided to guide the behavior and output of the LLM. An instruction may include commands, questions, constraints, requirements, contextual information, or any other guideline or direction guiding the behavior and output of the LLM. The one or more prompts may include any other suitable information for assigning labels to medical images. In one example, the instructions for assigning labels to medical images are as follows: “Find all CT (computed tomography) images from patients diagnosed with lung cancer and place the imaging exams in folder A and all patients without any signs of lung cancer in folder B.”

In one embodiment, the one or more prompts further comprise additional instructions for assigning a level of confidence to each of the assigned labels. For example, the additional instructions may be as follows: “Assign each medical image a level of confidence based on the fidelity of the underlying information.” The level of confidence may be represented in any suitable form, as defined by the additional instructions. For example, the level of confidence may be represented as a high, medium, or low level of confidence, as a percentage, as a score, or in any other suitable form. The additional instructions may further define criteria for assigning the level of confidence to each of the assigned labels based on the underlying patient data the LLM uses to assign the labels. For example, for positive examples of lung cancer, the additional instructions may define the criteria as follows: “Assign labels determined based on positive histopathology information a high level of confidence, labels determined based on a PET (positron emission tomography) CT scan with positive FDG (fluorodeoxyglucose) uptake in the region of the lesion a medium level of confidence, and labels determined based on suspicion indicated by a radiologist based on imaging findings a low level of confidence.” In another example, for negative example of lung cancer, the additional instructions may define the criteria as follows: “Assign labels determined based on negative histopathology information a high level of confidence, labels determined based on a patient having several follow-up CT images with the lesion not growing thus indicating the lesion is stable and no malignant a medium level of confidence, and labels determined based on a radiologist report a low level of confidence.”

At step 104 of FIG. 1, the labels are assigned to the medical images using a large language model based on 1) the instructions and 2) patient data stored in a plurality of patient databases. The large language model is communicatively coupled to existing IT (information technology) systems, enabling the large language model to communicate and interact with the plurality of patient databases to gather, connect, structure, etc. the patient data.

The medical images may be of any suitable modality, such as, e.g., CT (computed tomography), MRI (magnetic resonance imaging), ultrasound, x-ray, or any other medical imaging modality or combinations of medical imaging modalities. In one embodiment, the patient data comprises data of one or more patients, such as, e.g., medical images, medical records, laboratory reports, radiology reports, indications for imaging/examination, demographic information, administrative data, etc. stored across the plurality of patient databases. The patient data may include any other suitable data of a patient. The patient data may be represented in the form of unstructured free text, tables, or any other suitable format using different nomenclature, for example, where the patient data is retrieved from a plurality of different patient databases.

In one embodiment, the patient data comprises measurements and other information extracted from medical images. The extracted measurements and information may be manually extracted (e.g., by a radiologist or other clinician) and/or automatically from the medical images using AI (artificial intelligence) based systems performing one or more medical imaging analysis tasks (e.g., detection, classification, segmentation, etc.). The extracted measurements and information may be represented in one or more tables or in any other suitable format.

The patient data is stored in a plurality of patient databases. The patient databases may include, for example, an EHR (electronic health record), EMR (electronic medical record), PHR (personal health record), HIS (health information system), RIS (radiology information system), PACS (picture archiving and communication system), LIMS (laboratory information management system), a pathology database, or any other database or system suitable for storing patient data.

The large language model receives as input the one or more prompts and generates as output the assignment of the labels to the medical images. The large language model may be any suitable pre-trained deep learning based large language model. For example, the large language model may be based on the transformer architecture, which uses a self-attention mechanism to capture long-range dependencies in text. One example of a transformer-based architecture is GPT (generative pre-training transformer), which has a multilayer transformer decoder architecture that may be pretrained to optimize the next token prediction task and then fine-tuned with labelled data for various downstream tasks. GPT-based large language models may be trained using reinforcement learning with human feedback for performing various natural language processing tasks. Other exemplary transformer-based architectures include BLOOM (BigScience Large Open-science Open-access Multilingual Language Model) and BERT (Bidirectional Encoder Representations from Transfers).

In one embodiment, the large language model is constrained to a specific medical domain. To constrain the LLM, the LLM may be updated (e.g., trained, retrained, or fine-tuned) using, e.g., clinical data and data extracted from medical images using AI-based systems. Such extracted data may include, e.g., clinical measurements (e.g., diameters, volumes, distances, etc.), anatomical locations, detections, etc.

In one embodiment, in response to receiving the one or more prompts comprising the additional instructions, each of the assigned labels are assigned a level of confidence using the large language model based on the additional instructions. The level of confidence is determined by the large language model based on the underlying patient data from which the large language model assigns the label, in accordance with the criteria defined in the additional instructions.

In one example, as shown in workflow 200 of FIG. 2, the large language model is large language model 208, which receives as input patient information 202 and generates as output the assignment 210-A of a positive label for lung cancer and assignment 210-B of a negative label for lung cancer. Patient information 202 comprises indication for exam 206-A, reports 206-B, and imaging 206-C stored in laboratory information system 204-A, pathology database 204-B, EMR 204-C, radiology information system 204-D, and PACS 204-E (collectively referred to as patient databases 204). The assignment of labels for each medical image is also assigned a level of confidence 212, represented in workflow 200 as a percentage.

At step 106 of FIG. 1, the assignment of the labels to the medical images and/or the assignment of the level of confidence to the assigned labels is output. For example, the assignment of the labels to the medical images and/or the assignment of the level of confidence to the assigned labels can be output by displaying the assignments on a display device of a computer system (e.g., computer 502 of FIG. 5), storing the assignments on a memory or storage of a computer system, or by transmitting the assignments to a remote computer system.

In one embodiment, the assignment of the labels to the medical images is output by storing the medical images according to a file structure defined based on the assigned labels by the large language model. In this embodiment, a computer folder or a storage space in a computer may be defined for each assigned label. For example, folder A may be defined for images assigned to positive labels of lung cancer and folder B may be defined for images assigned to negative labels of lung cancer. The large language model then stores the medical images in the folder defined for their assigned labels in accordance with the instructions received in the one or more prompts. The large language model communicates and interacts with the existing IT systems to store the medical images in the folders defined for its assigned label by, e.g., transferring the medical images from the patient databases to the folders, storing a copy of the medical images in the folders, or any other suitable manner for storing the medical images in the folders.

At step 108 of FIG. 1, an AI (artificial intelligence) system is trained for performing a medical imaging analysis task based on the medical images and the assigned labels. In one example, as shown in workflow 200 of FIG. 2, the AI system is imaging AI model 214 trained based on assignment 210-A of positive labels for lung cancer and assignment 210-B of negative labels for lung cancer. The AI system may be implemented according to any suitable AI or machine learning based architecture for performing the medical imaging analysis task. In one example, the medical imaging analysis task is the identification of malignant or high-risk nodules in the lungs of a patient. However, the medical imaging analysis task may include any other suitable medica imaging analysis task, such as, for example, detection, classification, segmentation, quantification, etc.

Advantageously, the assignment of labels to medical images is performed in accordance with embodiments described herein with comprehensive patient data stored across a plurality of patient databases, while also assigning a level of confidence to the assignment of labels to each medical image. Accordingly, AI systems trained on the medical images and assigned labels in accordance with embodiments described herein have a performance significantly better than the performance of other AI system trained only with imaging data revied based on radiology reports or human annotations. Further, no additional effort is required to manually label the medical images.

Embodiments described herein are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the providing system.

Furthermore, certain embodiments described herein are described with respect to methods and systems utilizing trained machine learning based models, as well as with respect to methods and systems for training machine learning based models. Features, advantages or alternative embodiments herein can be assigned to the other claimed objects and vice versa. In other words, claims for methods and systems for training a machine learning based model can be improved with features described or claimed in context of the methods and systems for utilizing a trained machine learning based model, and vice versa.

In particular, the trained machine learning based models applied in embodiments described herein can be adapted by the methods and systems for training the machine learning based models. Furthermore, the input data of the trained machine learning based model can comprise advantageous features and embodiments of the training input data, and vice versa. Furthermore, the output data of the trained machine learning based model can comprise advantageous features and embodiments of the output training data, and vice versa.

In general, a trained machine learning based model mimics cognitive functions that humans associate with other human minds. In particular, by training based on training data, the trained machine learning based model is able to adapt to new circumstances and to detect and extrapolate patterns.

In general, parameters of a machine learning based model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the trained machine learning based model can be adapted iteratively by several steps of training.

In particular, a trained machine learning based model can comprise a neural network, a support vector machine, a decision tree, and/or a Bayesian network, and/or the trained machine learning based model can be based on k-means clustering, Q-learning, genetic algorithms, and/or association rules. In particular, a neural network can be a deep neural network, a convolutional neural network, or a convolutional deep neural network. Furthermore, a neural network can be an adversarial network, a deep adversarial network and/or a generative adversarial network.

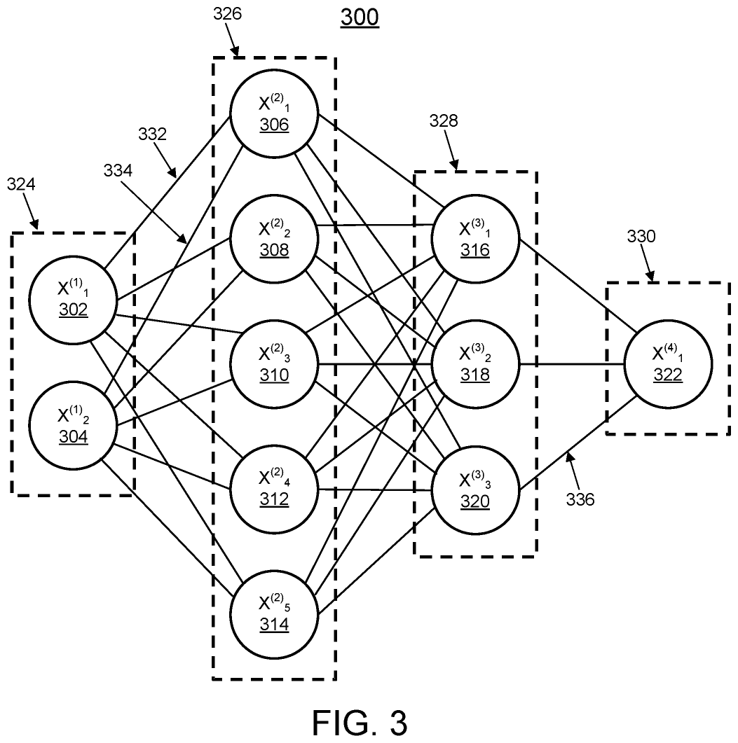

FIG. 3 shows an embodiment of an artificial neural network 300, in accordance with one or more embodiments. Alternative terms for “artificial neural network” are “neural network”, “artificial neural net” or “neural net”. Machine learning networks described herein, such as, e.g., the large language model utilized at step 104 and the AI system utilized at step 108 of FIG. 1 and large language model 208 and imaging AI model 214 of FIG. 2, may be implemented using artificial neural network 300.

The artificial neural network 300 comprises nodes 302-322 and edges 332, 334, . . . , 336, wherein each edge 332, 334, . . . , 336 is a directed connection from a first node 302-322 to a second node 302-322. In general, the first node 302-322 and the second node 302-322 are different nodes 302-322, it is also possible that the first node 302-322 and the second node 302-322 are identical. For example, in FIG. 3, the edge 332 is a directed connection from the node 302 to the node 306, and the edge 334 is a directed connection from the node 304 to the node 306. An edge 332, 334, . . . , 336 from a first node 302-322 to a second node 302-322 is also denoted as “ingoing edge” for the second node 302-322 and as “outgoing edge” for the first node 302-322.

In this embodiment, the nodes 302-322 of the artificial neural network 300 can be arranged in layers 324-330, wherein the layers can comprise an intrinsic order introduced by the edges 332, 334, . . . , 336 between the nodes 302-322. In particular, edges 332, 334, . . . , 336 can exist only between neighboring layers of nodes. In the embodiment shown in FIG. 3, there is an input layer 324 comprising only nodes 302 and 304 without an incoming edge, an output layer 330 comprising only node 322 without outgoing edges, and hidden layers 326, 328 in-between the input layer 324 and the output layer 330. In general, the number of hidden layers 326, 328 can be chosen arbitrarily. The number of nodes 302 and 304 within the input layer 324 usually relates to the number of input values of the neural network 300, and the number of nodes 322 within the output layer 330 usually relates to the number of output values of the neural network 300.

In particular, a (real) number can be assigned as a value to every node 302-322 of the neural network 300. Here, x⁽ⁿ⁾i denotes the value of the i-th node 302-322 of the n-th layer 324-330. The values of the nodes 302-322 of the input layer 324 are equivalent to the input values of the neural network 300, the value of the node 322 of the output layer 330 is equivalent to the output value of the neural network 300. Furthermore, each edge 332, 334, . . . , 336 can comprise a weight being a real number, in particular, the weight is a real number within the interval [−1, 1] or within the interval [0, 1]. Here, w^{(m,n)}_{i,j} denotes the weight of the edge between the i-th node 302-322 of the m-th layer 324-330 and the j-th node 302-322 of the n-th layer 324-330. Furthermore, the abbreviation w(ⁿ)_{i,j} is defined for the weight w^{(n,n+1)}_{i,j}.

In particular, to calculate the output values of the neural network 300, the input values are propagated through the neural network. In particular, the values of the nodes 302-322 of the (n+1)-th layer 324-330 can be calculated based on the values of the nodes 302-322 of the n-th layer 324-330 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 324 are given by the input of the neural network 300, wherein values of the first hidden layer 326 can be calculated based on the values of the input layer 324 of the neural network, wherein values of the second hidden layer 328 can be calculated based in the values of the first hidden layer 326, etc.

In order to set the values w(^{m,n})_{i,j} for the edges, the neural network 300 has to be trained using training data. In particular, training data comprises training input data and training output data (denoted as ti). For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 330, wherein f′ is the first derivative of the activation function, and y⁽ⁿ⁺¹⁾ⱼ is the comparison training value for the j-th node of the output layer 330.

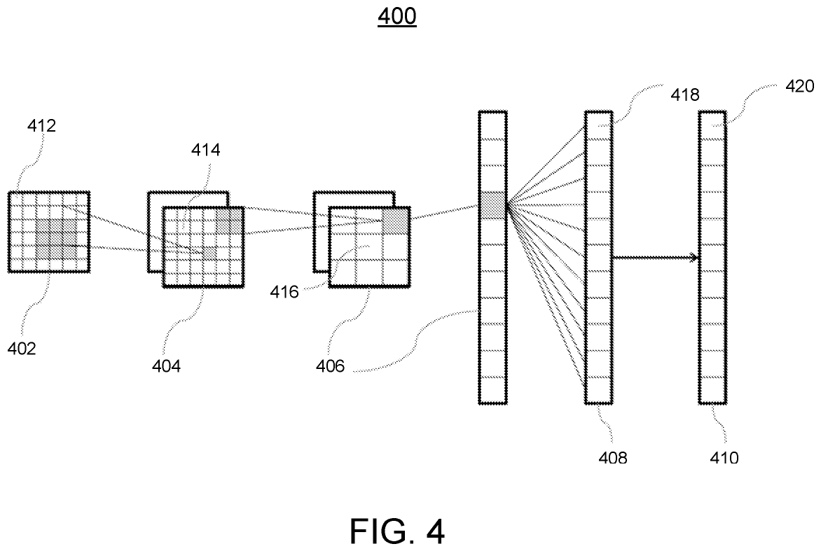

FIG. 4 shows a convolutional neural network 400, in accordance with one or more embodiments. Machine learning networks described herein, such as, e.g., the large language model utilized at step 104 and the AI system utilized at step 108 of FIG. 1 and large language model 208 and imaging AI model 214 of FIG. 2, may be implemented using convolutional neural network 400.

In the embodiment shown in FIG. 4, the convolutional neural network comprises 400 an input layer 402, a convolutional layer 404, a pooling layer 406, a fully connected layer 408, and an output layer 410. Alternatively, the convolutional neural network 400 can comprise several convolutional layers 404, several pooling layers 406, and several fully connected layers 408, as well as other types of layers. The order of the layers can be chosen arbitrarily, usually fully connected layers 408 are used as the last layers before the output layer 410.

In particular, within a convolutional neural network 400, the nodes 412-420 of one layer 402-410 can be considered to be arranged as a d-dimensional matrix or as a d-dimensional image. In particular, in the two-dimensional case the value of the node 412-420 indexed with i and j in the n-th layer 402-410 can be denoted as x⁽ⁿ⁾_{[j]}. However, the arrangement of the nodes 412-420 of one layer 402-410 does not have an effect on the calculations executed within the convolutional neural network 400 as such, since these are given solely by the structure and the weights of the edges.

In particular, a convolutional layer 404 is characterized by the structure and the weights of the incoming edges forming a convolution operation based on a certain number of kernels. In particular, the structure and the weights of the incoming edges are chosen such that the values x⁽ⁿ⁾k of the nodes 414 of the convolutional layer 404 are calculated as a convolution x⁽ⁿ⁾ₖ=Kₖ*x⁽ⁿ⁻¹⁾ based on the values x⁽ⁿ⁻¹⁾ of the nodes 412 of the preceding layer 402, where the convolution * is defined in the two-dimensional case as

$${x}_{k}^{( n )} [ i , j ] = ( {K}_{{k}^{*}} {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 412-418 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 412-420 in the respective layer 402-410. In particular, for a convolutional layer 404, the number of nodes 414 in the convolutional layer is equivalent to the number of nodes 412 in the preceding layer 402 multiplied with the number of kernels.

If the nodes 412 of the preceding layer 402 are arranged as a d-dimensional matrix, using a plurality of kernels can be interpreted as adding a further dimension (denoted as “depth” dimension), so that the nodes 414 of the convolutional layer 404 are arranged as a (d+1)-dimensional matrix. If the nodes 412 of the preceding layer 402 are already arranged as a (d+1)-dimensional matrix comprising a depth dimension, using a plurality of kernels can be interpreted as expanding along the depth dimension, so that the nodes 414 of the convolutional layer 404 are arranged also as a (d+1)-dimensional matrix, wherein the size of the (d+1)-dimensional matrix with respect to the depth dimension is by a factor of the number of kernels larger than in the preceding layer 402.

The advantage of using convolutional layers 404 is that spatially local correlation of the input data can exploited by enforcing a local connectivity pattern between nodes of adjacent layers, in particular by each node being connected to only a small region of the nodes of the preceding layer.

In embodiment shown in FIG. 4, the input layer 402 comprises 36 nodes 412, arranged as a two-dimensional 6×6 matrix. The convolutional layer 404 comprises 72 nodes 414, arranged as two two-dimensional 6×6 matrices, each of the two matrices being the result of a convolution of the values of the input layer with a kernel. Equivalently, the nodes 414 of the convolutional layer 404 can be interpreted as arranges as a three-dimensional 6×6×2 matrix, wherein the last dimension is the depth dimension.

A pooling layer 406 can be characterized by the structure and the weights of the incoming edges and the activation function of its nodes 416 forming a pooling operation based on a non-linear pooling function f. For example, in the two dimensional case the values x⁽ⁿ⁾ of the nodes 416 of the pooling layer 406 can be calculated based on the values x⁽ⁿ⁻¹⁾ of the nodes 414 of the preceding layer 404 as

$${x}^{( n )} [ i , j ] = f ( {x}^{( n - 1 )} [ {id}_{1} , {jd}_{2} ] , … , {x}^{( n - 1 )} [ i {d}_{1} + {d}_{1} - 1 , {jd}_{2} + {d}_{2} - 1 ] )$$

In other words, by using a pooling layer 406, the number of nodes 414, 416 can be reduced, by replacing a number d1·d2 of neighboring nodes 414 in the preceding layer 404 with a single node 416 being calculated as a function of the values of said number of neighboring nodes in the pooling layer. In particular, the pooling function f can be the max-function, the average or the L2-Norm. In particular, for a pooling layer 406 the weights of the incoming edges are fixed and are not modified by training.

The advantage of using a pooling layer 406 is that the number of nodes 414, 416 and the number of parameters is reduced. This leads to the amount of computation in the network being reduced and to a control of overfitting.

In the embodiment shown in FIG. 4, the pooling layer 406 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 408 can be characterized by the fact that a majority, in particular, all edges between nodes 416 of the previous layer 406 and the nodes 418 of the fully-connected layer 408 are present, and wherein the weight of each of the edges can be adjusted individually.

In this embodiment, the nodes 416 of the preceding layer 406 of the fully-connected layer 408 are displayed both as two-dimensional matrices, and additionally as non-related nodes (indicated as a line of nodes, wherein the number of nodes was reduced for a better presentability). In this embodiment, the number of nodes 418 in the fully connected layer 408 is equal to the number of nodes 416 in the preceding layer 406. Alternatively, the number of nodes 416, 418 can differ.

Furthermore, in this embodiment, the values of the nodes 420 of the output layer 410 are determined by applying the Softmax function onto the values of the nodes 418 of the preceding layer 408. By applying the Softmax function, the sum the values of all nodes 420 of the output layer 410 is 1, and all values of all nodes 420 of the output layer are real numbers between 0 and 1.

A convolutional neural network 400 can also comprise a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks can be wired using summation (residual/dense neural networks), element-wise multiplication (attention) or other differentiable operators. Therefore, the convolutional neural network architecture can be nested rather than being sequential if the whole pipeline is differentiable.

In particular, convolutional neural networks 400 can be trained based on the backpropagation algorithm. For preventing overfitting, methods of regularization can be used, e.g. dropout of nodes 412-420, stochastic pooling, use of artificial data, weight decay based on the L1 or the L2 norm, or max norm constraints. Different loss functions can be combined for training the same neural network to reflect the joint training objectives. A subset of the neural network parameters can be excluded from optimization to retain the weights pretrained on another datasets.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIG. 1 or 2. Certain steps or functions of the methods and workflows described herein, including one or more of the steps or functions of FIG. 1 or 2, may be performed by a server or by another processor in a network-based cloud-computing system. Certain steps or functions of the methods and workflows described herein, including one or more of the steps of FIG. 1 or 2, may be performed by a client computer in a network-based cloud computing system. The steps or functions of the methods and workflows described herein, including one or more of the steps of FIG. 1 or 2, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIG. 1 or 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 502 that may be used to implement systems, apparatus, and methods described herein is depicted in FIG. 5. Computer 502 includes a processor 504 operatively coupled to a data storage device 512 and a memory 510. Processor 504 controls the overall operation of computer 502 by executing computer program instructions that define such operations. The computer program instructions may be stored in data storage device 512, or other computer readable medium, and loaded into memory 510 when execution of the computer program instructions is desired. Thus, the method and workflow steps or functions of FIG. 1 or 2 can be defined by the computer program instructions stored in memory 510 and/or data storage device 512 and controlled by processor 504 executing the computer program instructions. For example, the computer program instructions can be implemented as computer executable code programmed by one skilled in the art to perform the method and workflow steps or functions of FIG. 1 or 2. Accordingly, by executing the computer program instructions, the processor 504 executes the method and workflow steps or functions of FIG. 1 or 2. Computer 502 may also include one or more network interfaces 506 for communicating with other devices via a network. Computer 502 may also include one or more input/output devices 508 that enable user interaction with computer 502 (e.g., display, keyboard, mouse, speakers, buttons, etc.).

Processor 504 may include both general and special purpose microprocessors, and may be the sole processor or one of multiple processors of computer 502. Processor 504 may include one or more central processing units (CPUs), for example. Processor 504, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 502.

An image acquisition device 514 can be connected to the computer 502 to input image data (e.g., medical images) to the computer 502. It is possible to implement the image acquisition device 514 and the computer 502 as one device. It is also possible that the image acquisition device 514 and the computer 502 communicate wirelessly through a network. In a possible embodiment, the computer 502 can be located remotely with respect to the image acquisition device 514.

Any or all of the systems and apparatus discussed herein may be implemented using one or more computers such as computer 502.

One skilled in the art will recognize that an implementation of an actual computer or computer system may have other structures and may contain other components as well, and that FIG. 5 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The following is a list of non-limiting illustrative embodiments disclosed herein:

Illustrative embodiment 1: A computer-implemented method comprising: receiving one or more prompts comprising instructions for assigning labels to medical images; assigning the labels to the medical images using a large language model based on 1) the instructions and 2) patient data stored in a plurality of patient databases; and outputting the assignment of the labels to the medical images.

Illustrative embodiment 2. The computer-implemented method of Illustrative embodiment 1, wherein outputting the assignment of the labels to the medical images comprises: storing, by the large language model, the medical images according to a file structure defined based on the assigned labels.

Illustrative embodiment 3. The computer-implemented method according to one of the preceding embodiments, wherein storing, by the large language model, the medical images according to a file structure defined based on the assigned labels comprises: storing, by the large language model, the medical images in a computer folder defined for their assigned labels.

Illustrative embodiment 4. The computer-implemented method according to one of the preceding embodiments, wherein the one or more prompts further comprise additional instructions for assigning a level of confidence to each of the assigned labels, and assigning the labels to the medical images using a large language model comprises: assigning the level of confidence to each of the assigned labels using the large language model based on the additional instructions.

Illustrative embodiment 5. The computer-implemented method according to one of the preceding embodiments, wherein assigning the level of confidence to each of the assigned labels using the large language model based on the additional instructions comprises: assigning the level of confidence to each of the assigned labels based on the patient data used to assign the labels to the medical images.

Illustrative embodiment 6. The computer-implemented method according to one of the preceding embodiments, further comprising: training an artificial intelligence system for performing a medical imaging analysis task based on the medical images and the assigned labels.

Illustrative embodiment 7. The computer-implemented method according to one of the preceding embodiments, wherein the plurality of patient databases comprises at least one of EHR (electronic health record), EMR (electronic medical record), PHR (personal health record), HIS (health information system), RIS (radiology information system), PACS (picture archiving and communication system), and LIMS (laboratory information management system).

Illustrative embodiment 8. An apparatus comprising: means for receiving one or more prompts comprising instructions for assigning labels to medical images; means for assigning the labels to the medical images using a large language model based on 1) the instructions and 2) patient data stored in a plurality of patient databases; and means for outputting the assignment of the labels to the medical images.

Illustrative embodiment 9. The apparatus of Illustrative embodiment 8, wherein the means for outputting the assignment of the labels to the medical images comprises: means for storing, by the large language model, the medical images according to a file structure defined based on the assigned labels.

Illustrative embodiment 10. The apparatus of any one of Illustrative embodiments 8-9, wherein the means for storing, by the large language model, the medical images according to a file structure defined based on the assigned labels comprises: means for storing, by the large language model, the medical images in a computer folder defined for their assigned labels.

Illustrative embodiment 11. The apparatus of any one of Illustrative embodiments 8-10, wherein the one or more prompts further comprise additional instructions for assigning a level of confidence to each of the assigned labels, and the means for assigning the labels to the medical images using a large language model comprises: means for assigning the level of confidence to each of the assigned labels using the large language model based on the additional instructions.

Illustrative embodiment 12. The apparatus of any one of Illustrative embodiments 8-11, wherein the means for assigning the level of confidence to each of the assigned labels using the large language model based on the additional instructions comprises: means for assigning the level of confidence to each of the assigned labels based on the patient data used to assign the labels to the medical images.

Illustrative embodiment 13. The apparatus of any one of Illustrative embodiments 8-12, further comprising: means for training an artificial intelligence system for performing a medical imaging analysis task based on the medical images and the assigned labels.

Illustrative embodiment 14. The apparatus of any one of Illustrative embodiments 8-13, wherein the plurality of patient databases comprises at least one of EHR (electronic health record), EMR (electronic medical record), PHR (personal health record), HIS (health information system), RIS (radiology information system), PACS (picture archiving and communication system), and LIMS (laboratory information management system).

Illustrative embodiment 15. A non-transitory computer readable medium storing computer program instructions, the computer program instructions when executed by a processor cause the processor to perform operations comprising: receiving one or more prompts comprising instructions for assigning labels to medical images; assigning the labels to the medical images using a large language model based on 1) the instructions and 2) patient data stored in a plurality of patient databases; and outputting the assignment of the labels to the medical images.

Illustrative embodiment 16. The non-transitory computer readable medium of illustrative embodiment 15, wherein outputting the assignment of the labels to the medical images comprises: storing, by the large language model, the medical images according to a file structure defined based on the assigned labels.

Illustrative embodiment 17. The non-transitory computer readable medium of any one of Illustrative embodiments 15-16, wherein storing, by the large language model, the medical images according to a file structure defined based on the assigned labels comprises: storing, by the large language model, the medical images in a computer folder defined for their assigned labels.

Illustrative embodiment 18. The non-transitory computer readable medium of any one of Illustrative embodiments 15-17, wherein the one or more prompts further comprise additional instructions for assigning a level of confidence to each of the assigned labels, and assigning the labels to the medical images using a large language model comprises: assigning the level of confidence to each of the assigned labels using the large language model based on the additional instructions.

Illustrative embodiment 19. The non-transitory computer readable medium of any one of Illustrative embodiments 15-18, wherein assigning the level of confidence to each of the assigned labels using the large language model based on the additional instructions comprises: assigning the level of confidence to each of the assigned labels based on the patient data used to assign the labels to the medical images.

Illustrative embodiment 20. The non-transitory computer readable medium of any one of Illustrative embodiments 15-19, the operations further comprising: training an artificial intelligence system for performing a medical imaging analysis task based on the medical images and the assigned labels.

1. A computer-implemented method comprising:
receiving one or more prompts comprising instructions for assigning labels to medical images;
assigning the labels to the medical images using a large language model based on 1) the instructions and 2) patient data stored in a plurality of patient databases; and
outputting the assignment of the labels to the medical images.

2. The computer-implemented method of claim 1, wherein outputting the assignment of the labels to the medical images comprises:
storing, by the large language model, the medical images according to a file structure defined based on the assigned labels.

3. The computer-implemented method of claim 2, wherein storing, by the large language model, the medical images according to a file structure defined based on the assigned labels comprises:
storing, by the large language model, the medical images in a computer folder defined for their assigned labels.

4. The computer-implemented method of claim 1, wherein the one or more prompts further comprise additional instructions for assigning a level of confidence to each of the assigned labels, and assigning the labels to the medical images using a large language model comprises:
assigning the level of confidence to each of the assigned labels using the large language model based on the additional instructions.

5. The computer-implemented method of claim 4, wherein assigning the level of confidence to each of the assigned labels using the large language model based on the additional instructions comprises:
assigning the level of confidence to each of the assigned labels based on the patient data used to assign the labels to the medical images.

6. The computer-implemented method of claim 1, further comprising:
training an artificial intelligence system for performing a medical imaging analysis task based on the medical images and the assigned labels.

7. The computer-implemented method of claim 1, wherein the plurality of patient databases comprises at least one of EHR (electronic health record), EMR (electronic medical record), PHR (personal health record), HIS (health information system), RIS (radiology information system), PACS (picture archiving and communication system), and LIMS (laboratory information management system).

8. An apparatus comprising:
means for receiving one or more prompts comprising instructions for assigning labels to medical images;
means for assigning the labels to the medical images using a large language model based on 1) the instructions and 2) patient data stored in a plurality of patient databases; and
means for outputting the assignment of the labels to the medical images.

9. The apparatus of claim 8, wherein the means for outputting the assignment of the labels to the medical images comprises:
means for storing, by the large language model, the medical images according to a file structure defined based on the assigned labels.

10. The apparatus of claim 9, wherein the means for storing, by the large language model, the medical images according to a file structure defined based on the assigned labels comprises:
means for storing, by the large language model, the medical images in a computer folder defined for their assigned labels.

11. The apparatus of claim 8, wherein the one or more prompts further comprise additional instructions for assigning a level of confidence to each of the assigned labels, and the means for assigning the labels to the medical images using a large language model comprises:
means for assigning the level of confidence to each of the assigned labels using the large language model based on the additional instructions.

12. The apparatus of claim 11, wherein the means for assigning the level of confidence to each of the assigned labels using the large language model based on the additional instructions comprises:
means for assigning the level of confidence to each of the assigned labels based on the patient data used to assign the labels to the medical images.

13. The apparatus of claim 8, further comprising:
means for training an artificial intelligence system for performing a medical imaging analysis task based on the medical images and the assigned labels.

14. The apparatus of claim 8, wherein the plurality of patient databases comprises at least one of EHR (electronic health record), EMR (electronic medical record), PHR (personal health record), HIS (health information system), RIS (radiology information system), PACS (picture archiving and communication system), and LIMS (laboratory information management system).

15. A non-transitory computer readable medium storing computer program instructions, the computer program instructions when executed by a processor cause the processor to perform operations comprising:
receiving one or more prompts comprising instructions for assigning labels to medical images;
assigning the labels to the medical images using a large language model based on 1) the instructions and 2) patient data stored in a plurality of patient databases; and
outputting the assignment of the labels to the medical images.

16. The non-transitory computer readable medium of claim 15, wherein outputting the assignment of the labels to the medical images comprises:
storing, by the large language model, the medical images according to a file structure defined based on the assigned labels.

17. The non-transitory computer readable medium of claim 16, wherein storing, by the large language model, the medical images according to a file structure defined based on the assigned labels comprises:
storing, by the large language model, the medical images in a computer folder defined for their assigned labels.

18. The non-transitory computer readable medium of claim 15, wherein the one or more prompts further comprise additional instructions for assigning a level of confidence to each of the assigned labels, and assigning the labels to the medical images using a large language model comprises:
assigning the level of confidence to each of the assigned labels using the large language model based on the additional instructions.

19. The non-transitory computer readable medium of claim 18, wherein assigning the level of confidence to each of the assigned labels using the large language model based on the additional instructions comprises:
assigning the level of confidence to each of the assigned labels based on the patient data used to assign the labels to the medical images.

20. The non-transitory computer readable medium of claim 15, the operations further comprising:
training an artificial intelligence system for performing a medical imaging analysis task based on the medical images and the assigned labels.
